(19) United States
(12) Patent Application Publication
(10) Pub. No.: US 2011/0085121 A1
(43) Pub. Date: Apr. 14, 2011

(54) Fringe Field Switching Mode Liquid Crystal Display Device and Method of Fabricating the Same

(75) Inventors: Min Kyeong Jeon, Soowon-Si (KR); Moo Jong Kim, Icheon-Si (KR)

(73) Assignee: HYDIS TECHNOLOGIES CO., LTD., Icheon-Si (KR)

(21) Appl. No.: 12/899,335

(22) Filed: Oct. 6, 2010

(30) Foreign Application Priority Data
Oct. 8, 2009 (KR) 10-2009-0095554
Jun. 9, 2010 (KR) 10-2010-0054267

(51) Int. Cl. G02F 1/1343

(52) U.S. Cl. 349/141

(57) ABSTRACT

Provided is a fringe field switching (FFS) mode liquid crystal display device (LCD) and a method of fabricating the same that are capable of effectively improving image quality by reducing loads of gate lines and data lines and increasing a conventional storage capacitance.

### CROSS-REFERENCE TO RELATED APPLICATION

This application claims priorities to and the benefits of Korean Patent Application Nos. 2009-95554, filed on Oct. 8, 2009, and 2010-54267, filed on Jun. 9, 2010, the disclosure of which is incorporated herein by reference in its entirety.

### BACKGROUND

1. Field of the Invention

The present invention relates to a fringe field switching (FFS) mode liquid crystal display device (LCD) and a method of fabricating the same, and more particularly, to an FFS mode LCD and a method of fabricating the same that is capable of effectively improving image quality by reducing loads of a gate line and a data line and increasing a conventional storage capacitance Cst.

2. Discussion of Related Art

In general, an FFS mode LCD has been proposed to improve a low aperture ratio and transmittance of an in-plane switching (IPS) mode LCD and technology about the FFS mode LCD was filed as a Korean Patent Application No. 1998-0009243.

Meanwhile, Korean Patent Registration No. 0849599, filed by and issued to the applicant, entitled “FFS Mode LCD,” discloses an FFS mode LCD capable of differentially driving a liquid crystal adjacent to a data line and a liquid crystal adjacent to a pixel region to remove a black matrix formed on the data line and to prevent light from leaking.

That is, FIG. 1 is a plan view showing a portion of a pixel region of a lower substrate of a conventional FFS mode LCD, FIG. 2 is a cross-sectional view taken along line I-I′ of FIG. 1, and FIG. 3 is a cross-sectional view taken along line II-II′ of FIG. 1.

Referring to FIGS. 1 to 3, gate lines G and data lines 600, which are formed of an opaque metal, are disposed to perpendicularly intersect to form unit pixel regions on a lower substrate 100. A transparent common electrode 800 and a transparent pixel electrode 400 are disposed in the unit pixel region with an insulating layer 700 interposed therebetween. The transparent pixel electrode 400 is disposed on the same layer as the data line 600, for example, in a plate shape, and the transparent common electrode 800 is provided to have a plurality of slits by patterning a transparent conductive layer deposited on the insulating layer 700 and overlapping a predetermined region of the transparent pixel electrode 400.

An active pattern 500, in which an amorphous silicon (a-Si) layer and an n+ a-Si layer are sequentially deposited, and source and drain electrodes 600a and 600b are provided with a gate insulating layer 300 interposed therebetween on a gate electrode 200 among the gate lines G to form a thin film transistor (TFT) T. The drain electrode 600b is electrically connected to the transparent pixel electrode 400 to apply a data signal to a unit pixel.

The conventional FFS mode LCD has a smaller pixel size as resolution increases. Therefore, an area occupied by a contact hole for electrical connection between the drain electrode 600b and the transparent pixel electrode 400, the drain electrode, etc., is relatively increased to reduce an aperture ratio, and thus, an overlapping region between the transparent pixel electrode 400 and the transparent common electrode 800 forming the storage capacitance Cst is also reduced. Eventually, this causes problems such as increase in pixel voltage ΔVp, decrease in voltage holding ratio (VHR), decrease in image quality such as an afterimage or flicker, decrease in transmittance, and so on.

### SUMMARY OF THE INVENTION

The present invention is directed to an FFS mode LCD and a method of fabricating the same that are capable of forming an auxiliary storage capacitance depending on variation in pixel size due to high resolution and variation in conventional storage capacitance of each pixel, and maintaining or increasing the total storage capacitance to effectively improve image quality.

The present invention is also directed to an FFS mode LCD and a method of fabricating the same that are capable of forming transparent auxiliary capacitive electrodes depending on variation in pixel size due to high resolution and variation in conventional storage capacitance of each pixel, and reducing resistance of the transparent auxiliary capacitive electrodes and/or transparent common electrodes so as to improve the total load, and effectively improving the greenish phenomenon occurring at a specific pattern by making the return of a common voltage rapidly at the time of voltage holding.

According to an aspect of the present invention, there is provided a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines. The FFS mode LCD includes: a transparent pixel electrode disposed in the pixel region to adjust optical transmittance by applying an electric field to the liquid crystal layer, and a transparent common electrode spaced apart from and overlapping the transparent pixel electrode in a predetermined region with an insulating layer interposed therebetween, and a transparent auxiliary capacitive electrode spaced apart from and overlapping the transparent pixel electrode in a predetermined region with a gate insulating layer interposed therebetween. Here, the transparent auxiliary capacitive electrode is electrically connected to a common bus line formed on a non-display region of an outer periphery of the lower substrate through a predetermined contact hole, and the common bus line is connected to the transparent common electrode.

Here, the transparent auxiliary capacitive electrodes disposed in the pixel regions parallel to the gate line may be electrically connected to each other.

According to another aspect of the present invention, there is provided a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines. The FFS mode LCD includes: a predetermined common line for reducing resistances disposed on the same layer as the gate lines and spaced apart from each gate line; a transparent pixel electrode disposed in the unit pixel region to adjust optical transmittance by applying an electric field to the liquid crystal layer; a transparent common electrode spaced apart from and overlapping the transparent pixel electrode in a predetermined region with an insulating layer interposed therebetween; a transparent auxiliary capacitive electrode spaced apart from and overlapping the transparent pixel electrode in a predetermined region with a gate insulating layer interposed therebetween, wherein the transparent auxiliary capacitive electrode is formed covering a portion of the common lines for reducing resistance so as to be electrically connected to the common lines for reducing resistance.

Here, the transparent common electrode may be electrically connected to the transparent auxiliary capacitive electrode through a predetermined contact hole formed on the insulating layer and the gate insulating film.

In addition, the transparent common electrode may include a plurality of slits having a predetermined width.

Further, the transparent auxiliary capacitive electrode may have an area included in the transparent pixel electrode in a plan view.

Furthermore, the transparent pixel electrode may have a plate shape.

In addition, the transparent pixel electrode may be formed on the same layer as the data line.

According to another aspect of the present invention, there is provided a method of fabricating a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines. The method includes: forming a gate line including a gate electrode on a substrate; forming a transparent auxiliary capacitive electrode to overlap a portion of a transparent pixel electrode in each unit pixel region; forming a gate insulating layer on the entire upper part of the substrate to cover the gate line including the gate electrode and the transparent auxiliary capacitive electrode, and then forming the transparent pixel electrode in each unit pixel region on the gate insulating layer; forming an active pattern on a portion of the gate insulating layer on an upper part of the gate electrode, and forming a first contact hole in a non-display region of an outer periphery of the lower substrate to expose the transparent auxiliary capacitive electrode using a contact mask; forming source and drain electrodes and a data line on the portion of the gate insulating layer on the upper part of the gate electrode to constitute a switching device, and simultaneously, forming a common bus line in the non-display region of the outer periphery of the lower substrate to be electrically connected to the transparent auxiliary capacitive electrode through the first contact hole; forming an insulating layer on the resultant structure on which the switching device is formed, and forming a second contact hole in the non-display region of the outer periphery of the lower substrate; and forming a transparent common electrode on the insulating layer to overlap at least a portion of the transparent pixel electrode and to be electrically connected to the common bus line through the second contact hole.

Here, the transparent auxiliary capacitive electrodes disposed in the pixel regions parallel to the gate line may be electrically connected to each other.

According to another aspect of the present invention, there is provided a method of fabricating a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines. The method includes: forming a gate line including a gate electrode on a substrate, and at the same time, forming a common line for reducing resistance on the same layer as the gate lines using the same material as the gate lines to be spaced apart from each gate lines; forming a transparent auxiliary capacitive electrode covering a portion of the common lines for reducing resistance and overlapping a portion of a transparent pixel electrode in each unit pixel region; forming a gate insulating layer on the entire upper part of the substrate to cover the gate line including the gate electrode and the transparent auxiliary capacitive electrode; forming an active pattern on a portion of the gate insulating layer on an upper part of the gate electrode, and forming the transparent pixel electrode to be disposed in each unit pixel region on the gate insulating film; forming source and drain electrodes and a data line to constitute a switching device, and forming an insulating layer on the resultant structure on which the switching device is formed; and forming the transparent common electrode on the insulating layer.

Here, after the transparent pixel electrode is formed, the first contact hole is formed so that a predetermined region of the transparent auxiliary capacitive electrode is exposed, after the insulating layer is formed, the second contact hole is formed at the same position as that of the first contact hole so that a predetermined region of the transparent auxiliary capacitive electrode is exposed, and the transparent common electrode is formed to be electrically connected to the transparent auxiliary capacitive electrode through the first and second contact holes.

In addition, the transparent auxiliary capacitive electrode may have an area included in the transparent pixel electrode in a plan view.

Furthermore, the transparent pixel electrode may have a plate shape.

In addition, the transparent pixel electrode may be formed on the same layer as that of the data line.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a plan view showing a portion of a pixel region of a lower substrate of a conventional FFS mode LCD;

FIG. 2 is a cross-sectional view taken along line I-I′ of FIG. 1;

FIG. 3 is a cross-sectional view taken along line II-II′ of FIG. 1;

FIG. 4 is a plan view showing a portion of a pixel region of a lower substrate of an FFS mode LCD in accordance with an exemplary embodiment of the present invention;

FIGS. 5 to 8 are plan views sequentially showing steps of forming respective layers and overlapping the layers;

FIG. 9 is a cross-sectional view taken along line A-A′ of FIG. 4;

FIG. 10 is a cross-sectional view taken along line B-B′ of FIG. 4;

FIG. 11 is a plan view of an FFS mode LCD showing a portion of the layer of FIG. 4;

FIG. 12 is a cross-sectional view taken along line C-C′ of FIG. 11;

FIG. 13 is an equivalent circuit diagram showing a liquid crystal cell of an FFS mode LCD in accordance with an exemplary embodiment of the present invention;

FIG. 14 is a view showing simulation results for comparing optical transmittance of a transmission part and 1-dot of a conventional art and a first exemplary embodiment of the present invention;

FIG. 15 is a plan view showing a portion of a pixel region of a lower substrate of an FFS mode LCD in accordance with a second exemplary embodiment of the present invention;

FIG. 16 to FIG. 21 are plan views sequentially showing steps of forming respective layers and overlapping the layers;

FIG. 22 is a plan view showing a portion of a pixel region of a lower substrate of an FFS mode LCD in accordance with a third exemplary embodiment of the present invention;

FIG. 23 is a plan view showing a portion of a pixel region of a lower substrate of an FFS mode LCD in accordance with a fourth exemplary embodiment of the present invention;

FIG. 24 to FIG. 31 are plan views sequentially showing steps of forming respective layers and overlapping the layers;

FIG. 32 is a cross-sectional view taken along line D-D′ of FIG. 15;

FIG. 33 is a cross-sectional view taken along line E-E′ of FIG. 22; and

FIG. 34 is a cross-sectional view taken along line F-F′ of FIG. 23.

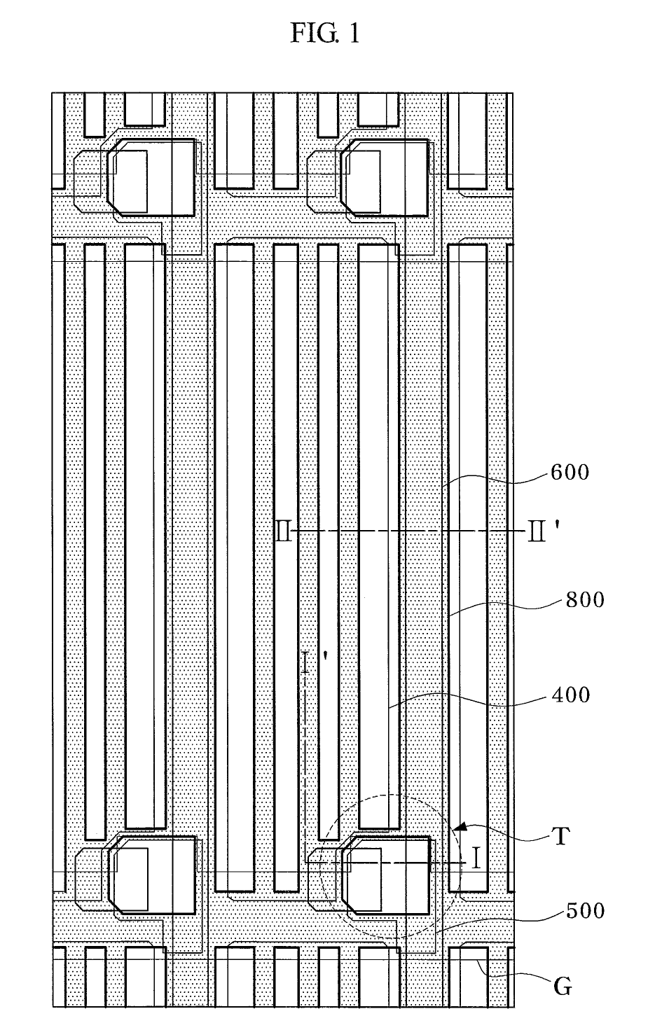

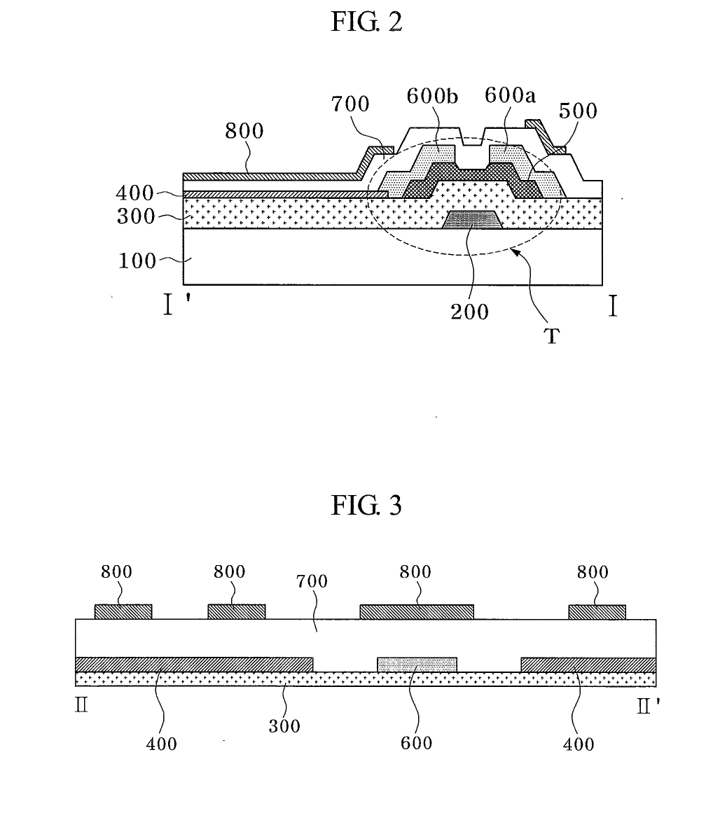

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

An FFS mode LCD in accordance with the present invention includes a lower substrate, an upper substrate, and a liquid crystal layer disposed therebetween. Gate lines and data lines are formed to intersect each other and to define pixel regions on the lower substrate. Switching devices are disposed on intersections of the gate lines and the data lines. In order to apply a voltage to the liquid crystal layer and adjust optical transmission, a transparent pixel electrode and a transparent common electrode spaced apart from the transparent pixel electrode are provided with an insulating layer interposed therebetween to overlap each other in a predetermined region.

### First Exemplary Embodiment

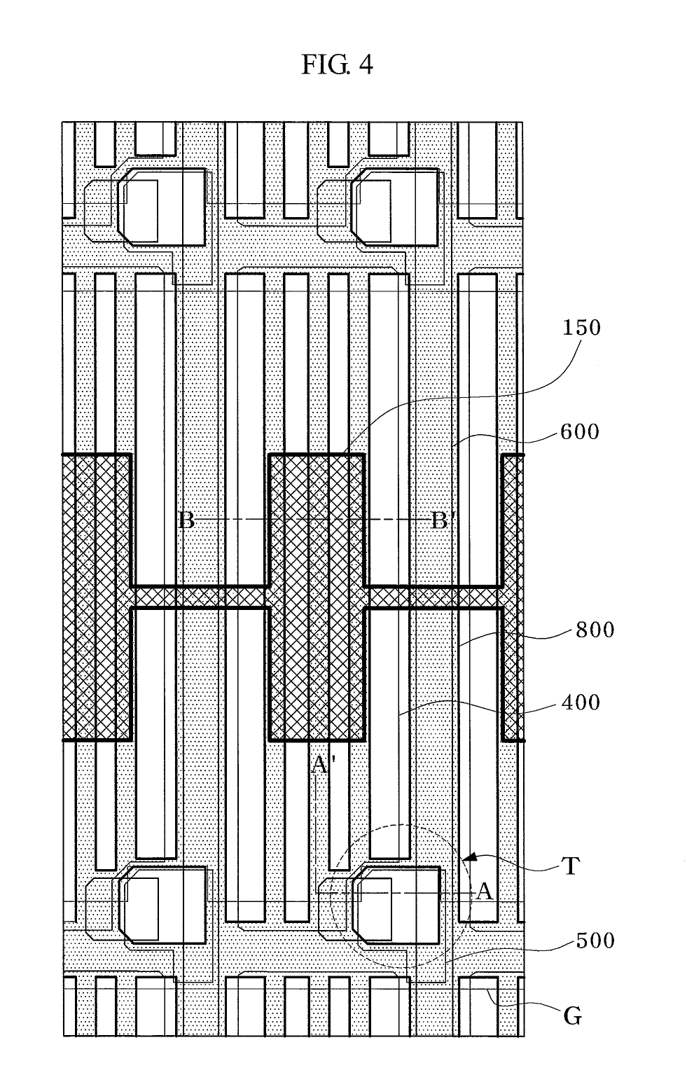

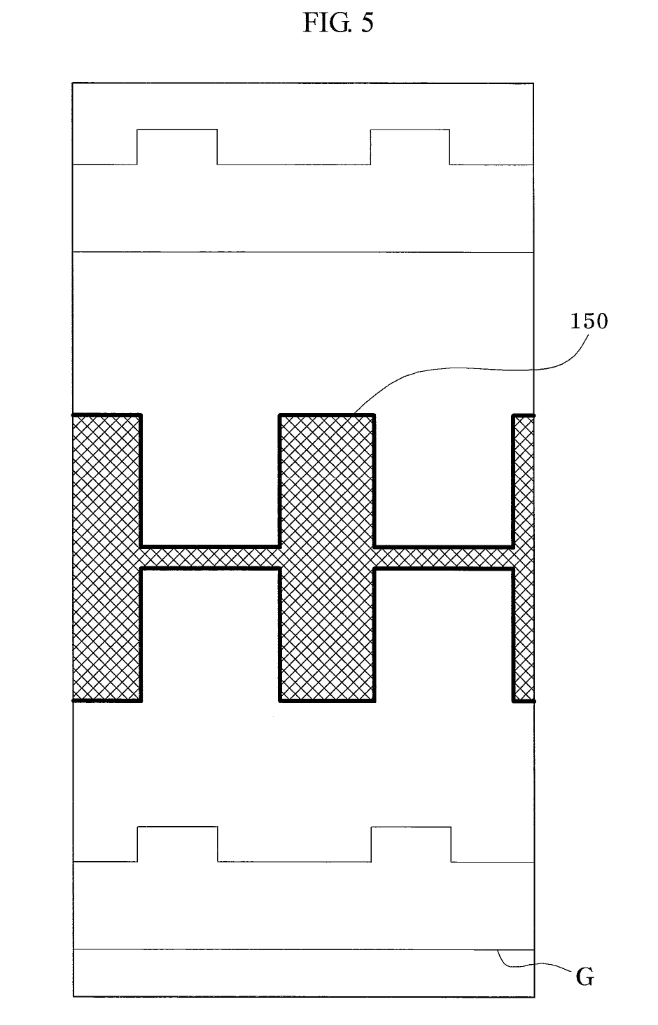

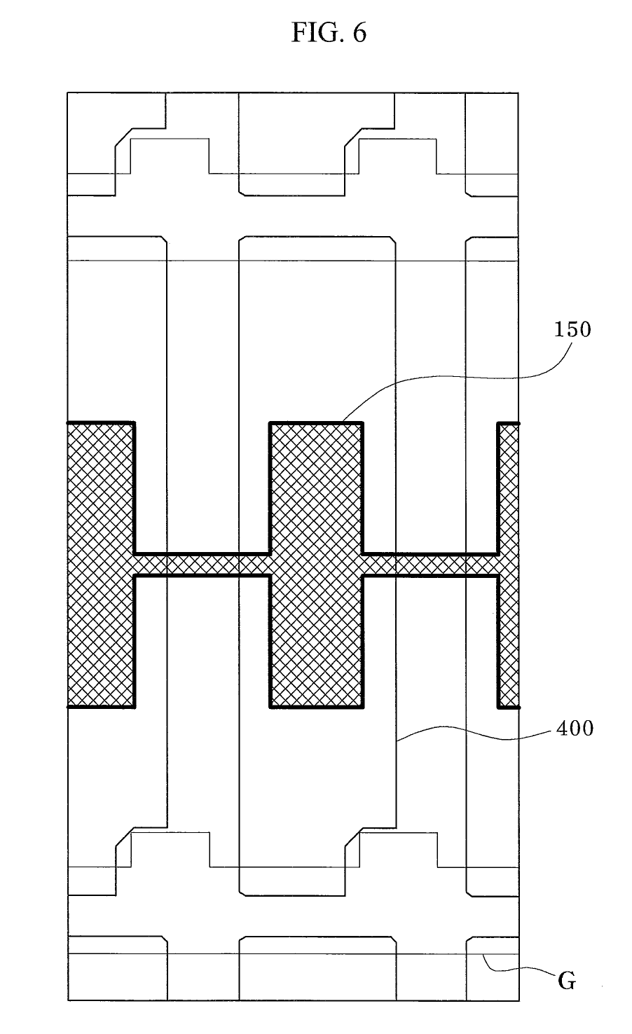

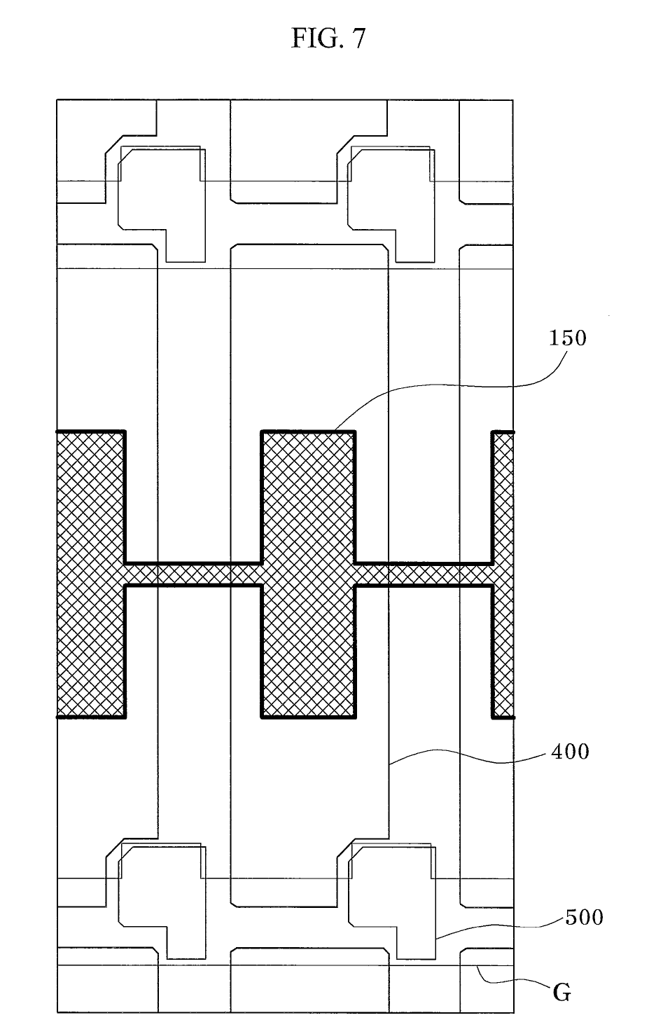

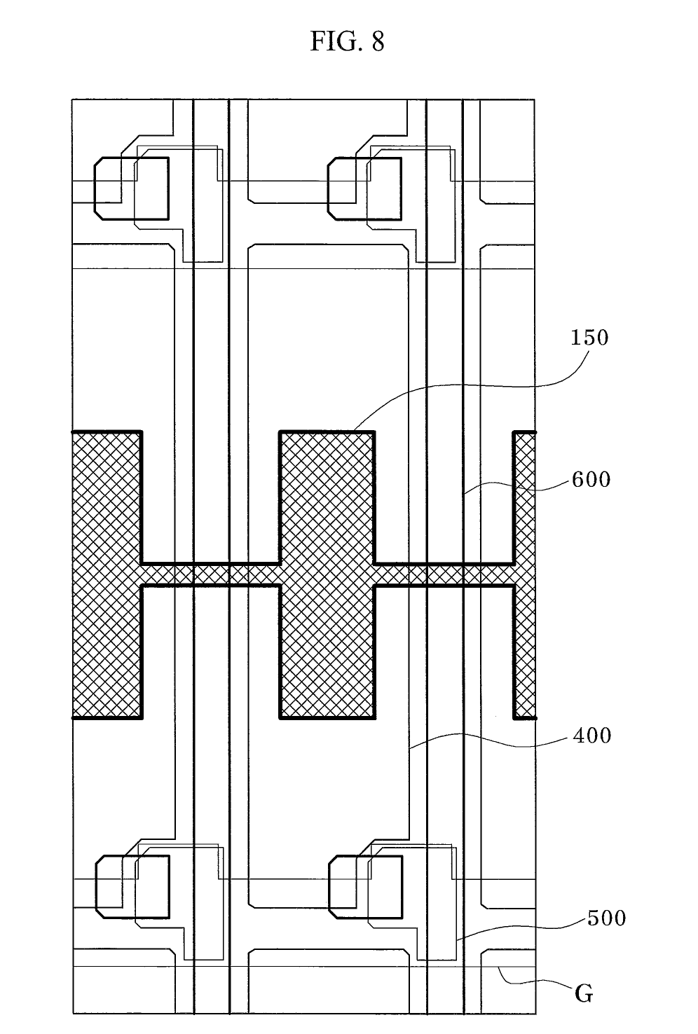

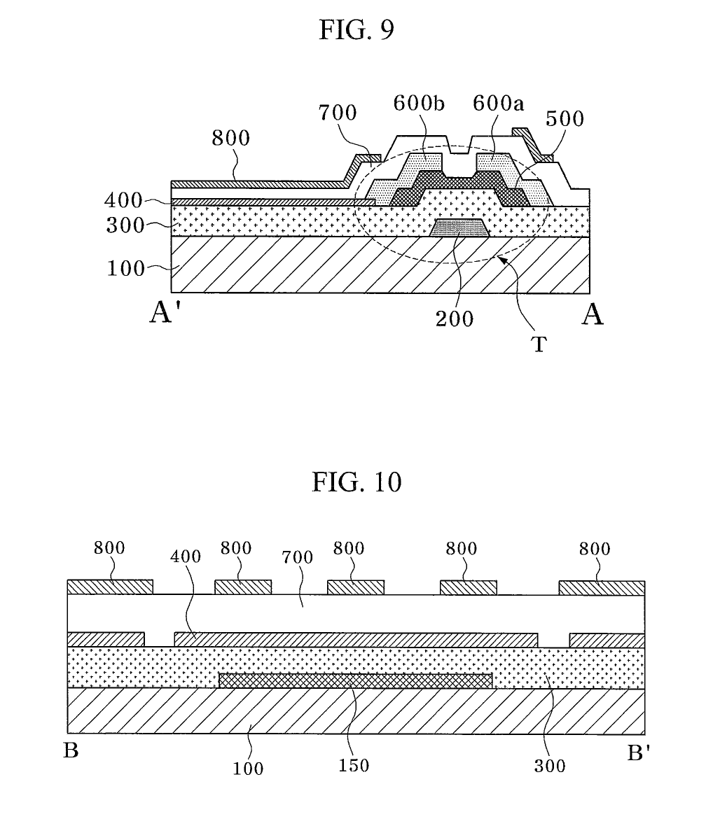

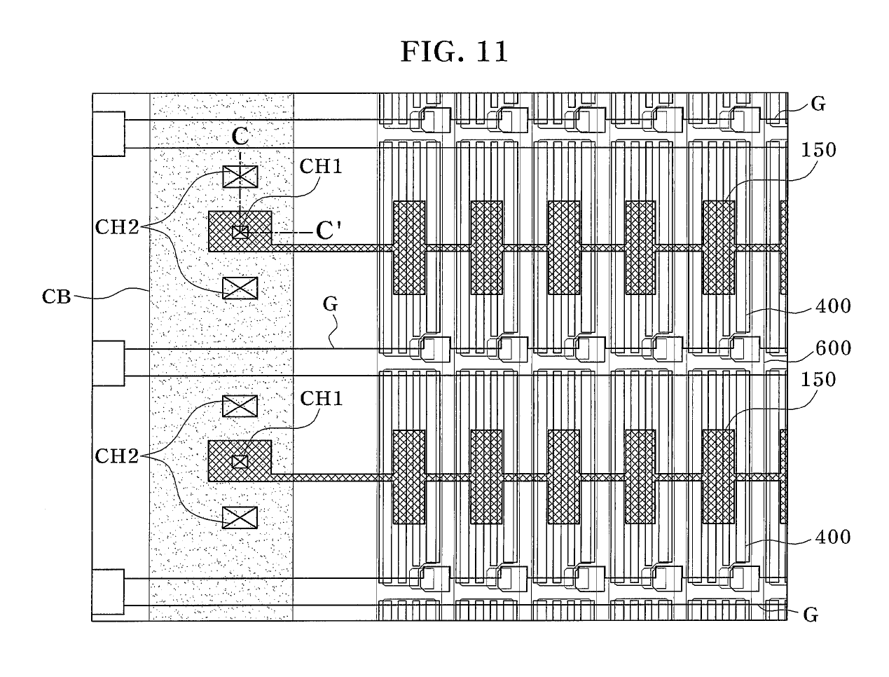

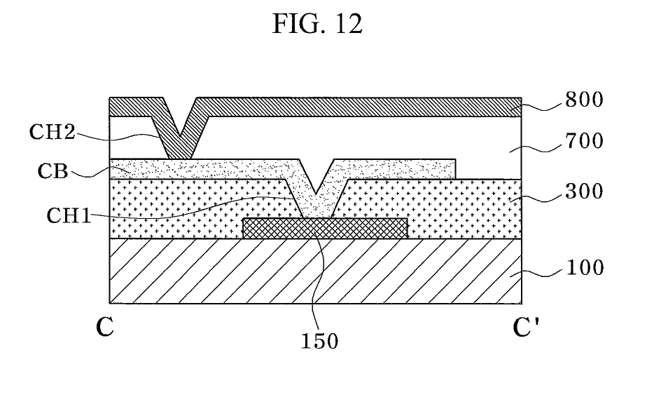

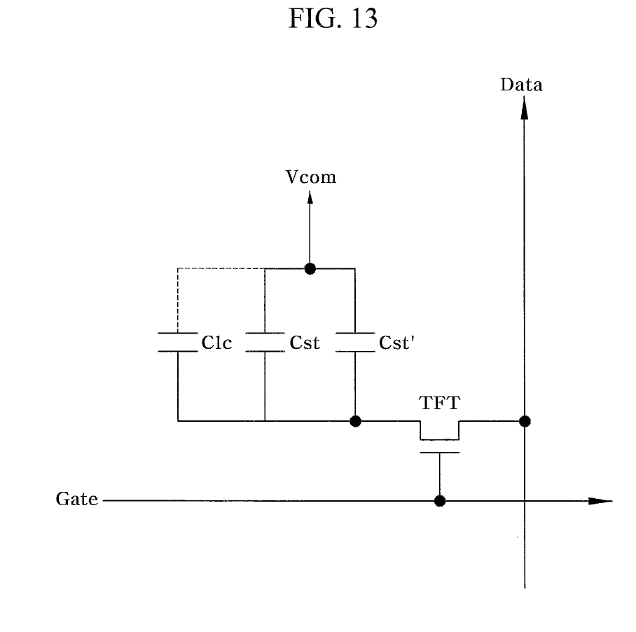

FIG. 4 is a plan view showing a portion of a pixel region of a lower substrate of an FFS mode LCD in accordance with a first exemplary embodiment of the present invention, FIGS. 5 to 8 are cross-sectional views sequentially showing steps of forming respective layers of FIG. 4 and overlapping the layers, FIG. 9 is a cross-sectional view taken along line A-A′ of FIG. 4, FIG. 10 is a cross-sectional view taken along line B-B′ of FIG. 4, FIG. 11 is a plan view of an FFS mode LCD showing a portion of the layer of FIG. 4, FIG. 12 is a cross-sectional view taken along line C-C′ of FIG. 11, and FIG. 13 is an equivalent circuit diagram showing a liquid crystal cell of an FFS mode LCD in accordance with a first exemplary embodiment of the present invention.

Referring to FIGS. 4 to 13, a lower substrate applied to the first exemplary embodiment of the present invention has a structure in which gate lines G and data lines 600 formed of an opaque metal (e.g. Mo and like) are disposed to intersect each other on a substrate 100 having an insulating property, forming unit pixel regions. A transparent common electrode 800 and a transparent pixel electrode 400 are formed in the unit pixel region with an insulating layer 700 interposed therebetween. The transparent pixel electrode 400 is disposed on the same layer as the data lines 600, for example, in a plate shape, and the transparent common electrode 800 has a plurality of slits formed by patterning a transparent conductive layer deposited on the insulating layer 700 and overlaps the transparent pixel electrode 400 in a predetermined region.

An active pattern 500, in which an a-Si layer and an n+ a-Si layer are sequentially deposited, and source and drain electrodes 600a and 600b are provided with a gate insulating layer 300 interposed therebetween on the gate electrode 200 among the gate lines C, forming a thin film transistor (TFT) T as a switching device. The drain electrode 600b is electrically connected to the transparent pixel electrode 400, thereby applying a data signal to a unit pixel.

In particular, in the first exemplary embodiment of the present invention, a transparent auxiliary capacitive electrode 150 disposed on the same layer as the gate line G formed on the lower substrate 100 before forming the gate insulating layer 300 is provided.

The transparent auxiliary capacitive electrode 150 is formed to overlap at least a portion of the transparent pixel electrode 400 in each unit pixel region, and preferably, has an area included in the transparent pixel electrode 400 in a plan view (in this case, an area of a connecting part connecting the transparent auxiliary capacitive electrodes 150 of each unit pixel region is excluded).

Meanwhile, the transparent auxiliary capacitive electrodes 150 provided in each unit pixel region parallel to the gate line G of each unit pixel region are electrically connected to each other. In addition, the transparent auxiliary capacitive electrodes 150 connected parallel to the gate lines G are electrically connected through a conventional common bus line CB and contact hole CH1 formed at a non-display region of an outer periphery of the lower substrate.

Here, the common bus line CB is formed at the non-display region of the outer periphery of the lower substrate along a circumference of the pixel region, and applies a common voltage signal Vcom to the transparent auxiliary capacitive electrodes 150 to form an additional auxiliary capacitance Cst′.

In addition, the common voltage signal Vcom is applied from the common bus line CB to the transparent common electrode 800 disposed on the substrate 100, and the common voltage signal Vcom cooperates with a pixel voltage of the transparent pixel electrode 400 formed on the substrate 100 to form a fringe field, thereby driving liquid crystal molecules.

Meanwhile, the transparent auxiliary capacitive electrode 150 may be formed of any one selected from indium tin oxide (ITO), tin oxide (TO), indium tin zinc oxide (ITZO), and indium zinc oxide (IZO).

As described above, the transparent auxiliary capacitive electrode 150 and the transparent pixel electrode 400 are spaced apart to overlap each other on the substrate 100 with the gate insulating layer 300 interposed therebetween. Therefore, a storage capacitance Cst is formed between the transparent pixel electrode 400 and the transparent common electrode 800 to maintain a data voltage charged to a liquid crystal cell Clc, and an auxiliary capacitance Cst′ is formed by the gate insulating layer 300 provided between the transparent pixel electrode 400 and the transparent auxiliary capacitive electrode 150.

The auxiliary capacitance Cst′ is directly connected to the common bus line CB through the contact hole CH to be connected parallel to the conventional storage capacitance Cst, thereby reducing loads of the gate line G and the data line 600 and effectively increasing the conventional storage capacitance Cst.

In addition, the magnitude of the auxiliary capacitance Cst′ may be optimally adjusted and freely formed depending on a pixel parameter and a drive load.

Meanwhile, according to the structure of the present invention, electric field for driving the liquid crystal layer is determined by the transparent pixel electrode 400 and the transparent common electrode 800, but electric field formed between the transparent auxiliary capacitive electrode 150 and the transparent pixel electrode 400 has no effect on the liquid crystal layer. This is because, in this structure, the transparent pixel electrode 400 has a plate shape, and the transparent auxiliary capacitive electrode 150 is formed under the plate shape so that electric field by the transparent auxiliary capacitive electrode 150 can be minimally applied to the liquid crystal layer. This means that a function of an auxiliary capacity of the transparent auxiliary capacitive electrode 150 is performed, and there is no problem in properties of the other entire LCD. Further, it may be more effective when the transparent auxiliary capacitive electrode 150 has a smaller area than the plate shape of the transparent pixel electrode 400 and is included in the transparent pixel electrode 400 (when the substrate is seen from above). For example, the transparent pixel electrode 400 has a rectangular plate shape, and the transparent auxiliary capacitive electrode 150 also has a rectangular structure included in the rectangular structure of the transparent pixel electrode.

Meanwhile, a color filter (not shown) for representing colors of a screen corresponding to the pixel regions formed on the lower substrate 100 is disposed on the upper substrate. A black matrix may or may not be formed on the data line 600.

Hereinafter, a method of fabricating an FFS mode LCD in accordance with the first exemplary embodiment of the present invention will be described in detail with reference to FIGS. 4 to 13.

Referring to FIGS. 4 to 13, in a lower substrate applied to the first exemplary embodiment of the present invention, a gate line G having a gate electrode 200 is first formed on a substrate 100, and a transparent auxiliary capacitive electrode 150 is formed on the same layer as the gate line G of the substrate 100.

That is, the gate line G including the gate electrode 200 is formed on the substrate 100 corresponding to a forming part of a TFT T through deposition of an opaque metal layer and patterning thereof, and the transparent auxiliary capacitive electrode 150 is formed on the substrate 100 to overlap a portion of a transparent pixel electrode 400 in each unit pixel region through deposition of a transparent metal layer and patterning thereof.

Here, the transparent auxiliary capacitive electrodes 150 formed on the unit pixel regions parallel to the gate line G may be electrically connected to each other.

Next, a gate insulating layer 300 is deposited on the entire upper part of the substrate 100 to cover the gate line G including the gate electrode 200 and the transparent auxiliary capacitive electrode 150, and then, the transparent pixel electrode 400 having a plate shape is formed in the unit pixel region on the gate insulating layer 300 through deposition of a transparent conductive layer and patterning thereof.

An a-Si layer and an n+ a-Si layer are sequentially deposited on the resultant substrate and then patterned to form an active pattern 500 on the gate insulating layer 300 corresponding to the gate electrode 200, and a contact hole CH1 is formed in the gate insulating layer 300, on which a common bus line CB is to be formed using a contact mask (not shown), to expose the transparent auxiliary capacitive electrode 150.

After this, a metal layer for source and drain electrodes is deposited and then patterned to form a data line 600 including source and drain electrodes 600a and 600b, thereby constituting a TFT T. Here, the drain electrode 600b is configured to be electrically connected to the transparent pixel electrode 400.

At the same time, the common bus line CB is formed on a non-display region of an outer periphery of the lower substrate. Here, the common bus line CB is configured to be electrically connected to the transparent auxiliary capacitive electrode 150 through the contact hole CH. In addition, the common bus line CB may be formed of the same material as the data line 600.

An insulating layer 700 formed of, for example, a SiNx material is applied on the resultant structure, in which the TFT T is formed, and then, a transparent common electrode 800 having a slit shape is formed to overlap at least a portion of the transparent pixel electrode 400. At this time, the transparent common electrode 800 is electrically connected to the common bus line CB through the contact hole CH2.

Next, while not shown, an alignment layer is applied on the uppermost part of the resultant substrate, on which the transparent common electrode 800 is formed, thereby completing the manufacture of an array substrate.

Meanwhile, a color filter is selectively formed on the upper substrate, and an alignment layer is formed thereon. The upper and lower substrates are bonded to each other with a liquid crystal layer interposed therebetween to complete the FFS mode LCD in accordance with the first exemplary embodiment of the present invention. Of course, after bonding the substrates, polarizers may be attached to outer surfaces of the substrates.

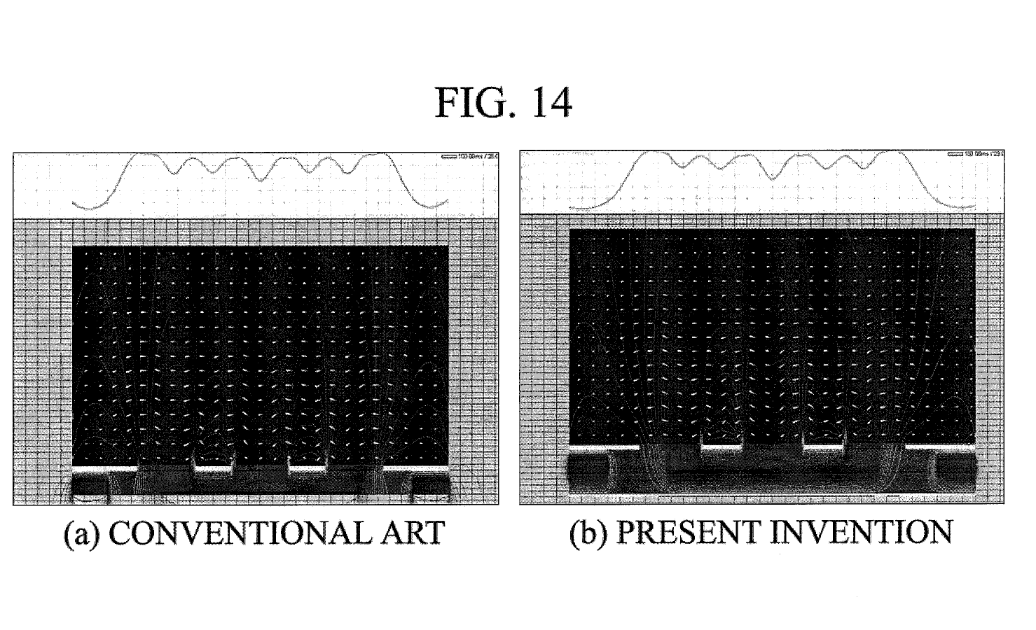

FIG. 14 is a view showing simulation results for comparing optical transmittance of a transmission part and 1-dot of a conventional art and the first exemplary embodiment of the present invention, and a graph illustrated on the upper part of a structure in which a transparent electrode 400, a transparent common electrode 800 and a transparent auxiliary capacitive electrode 150 are disposed represents optical transmittance.

### Second Exemplary Embodiment

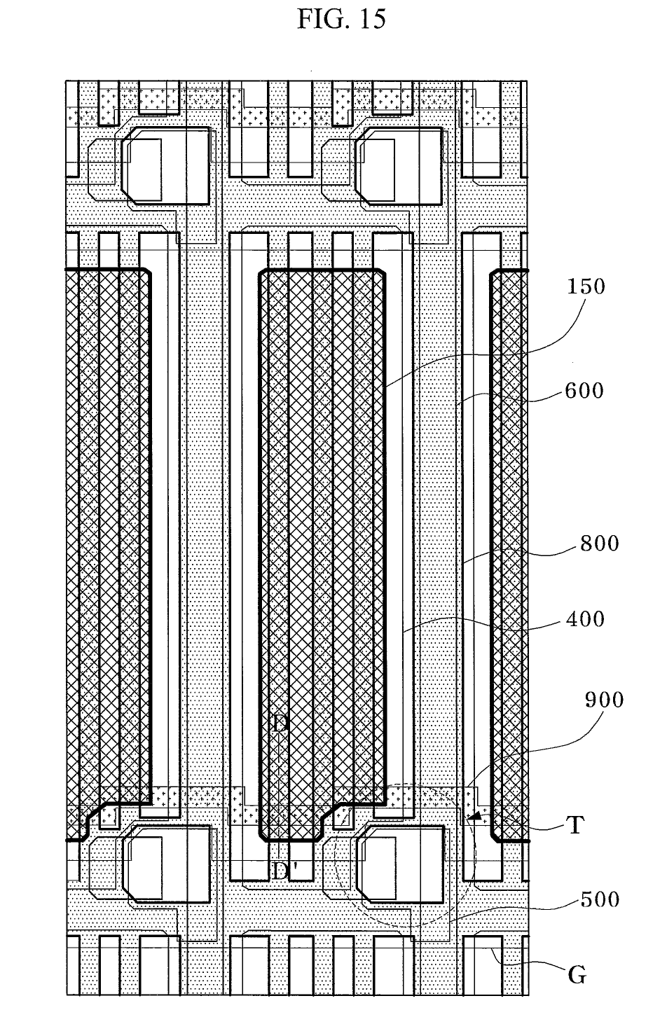

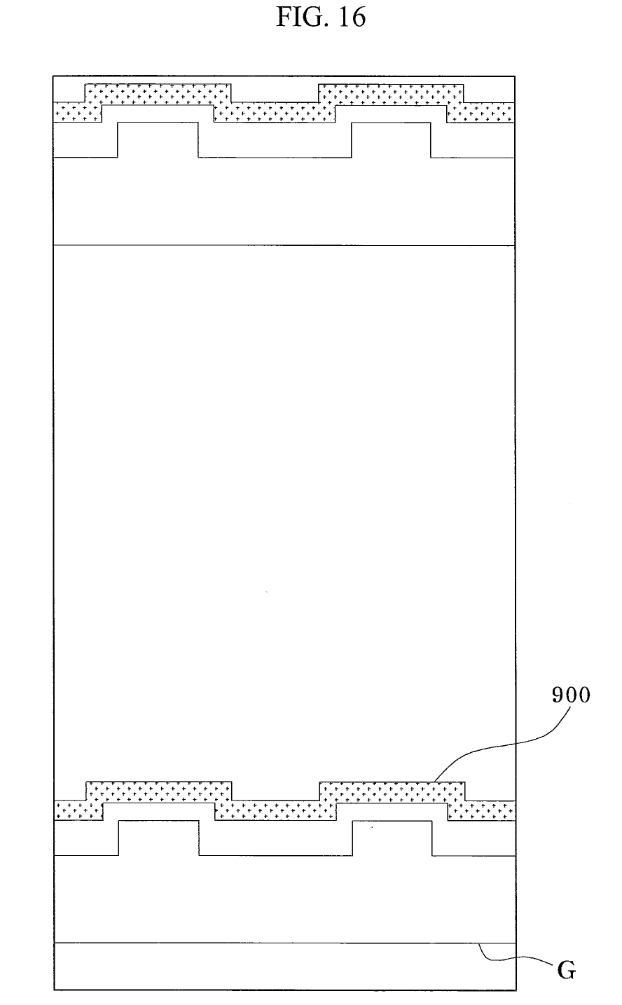

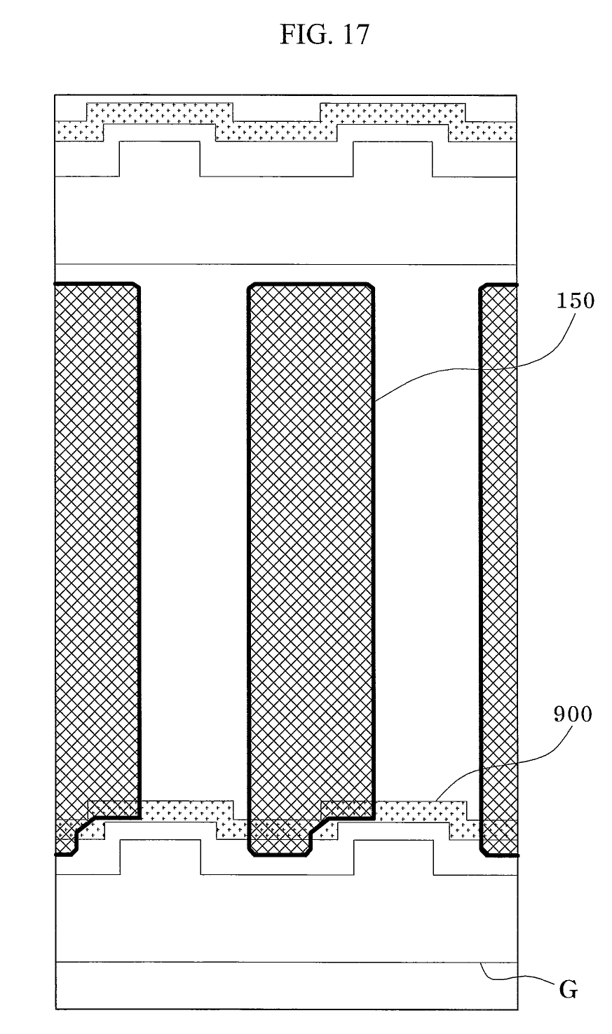

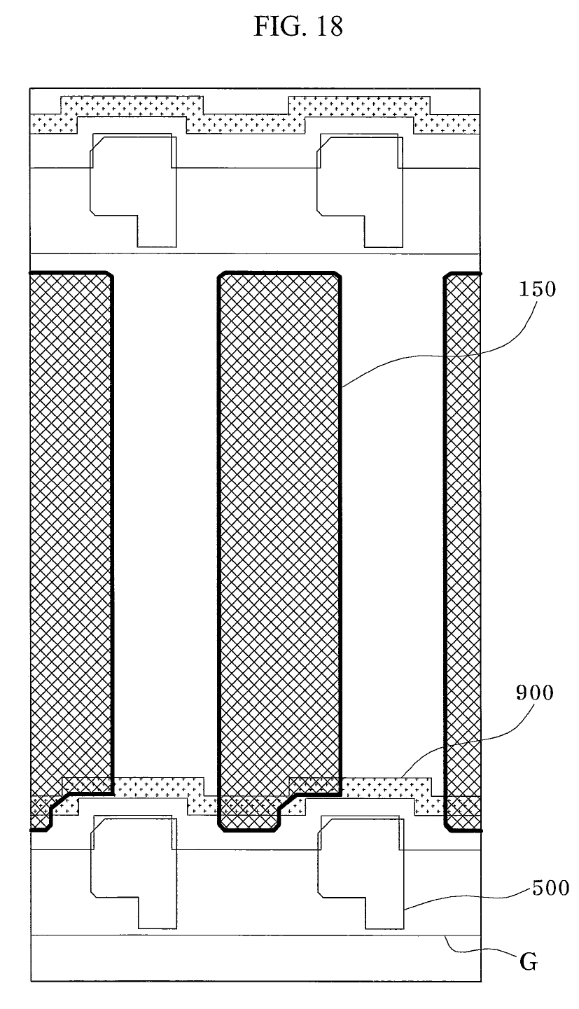

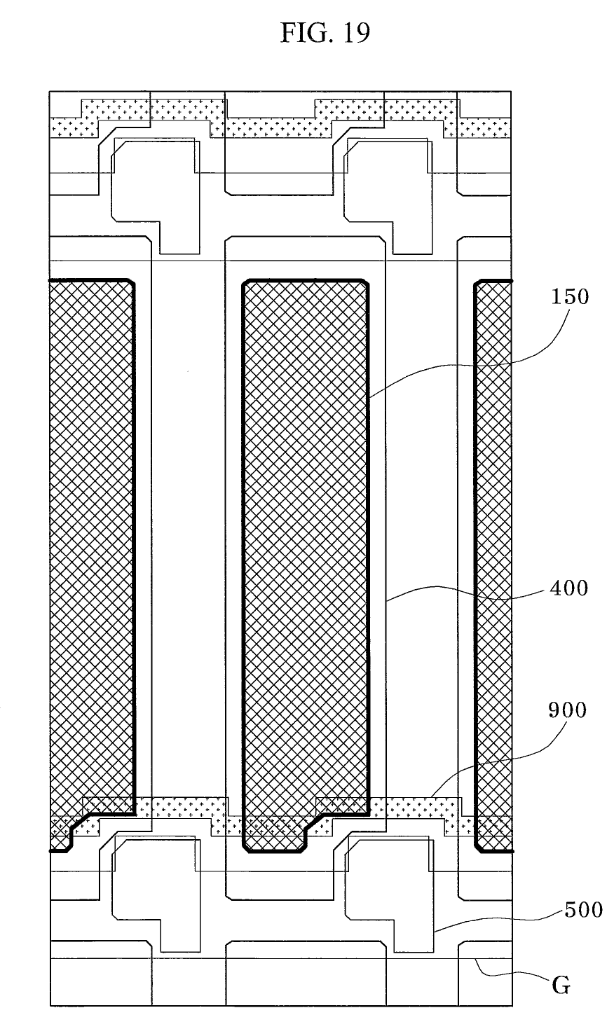

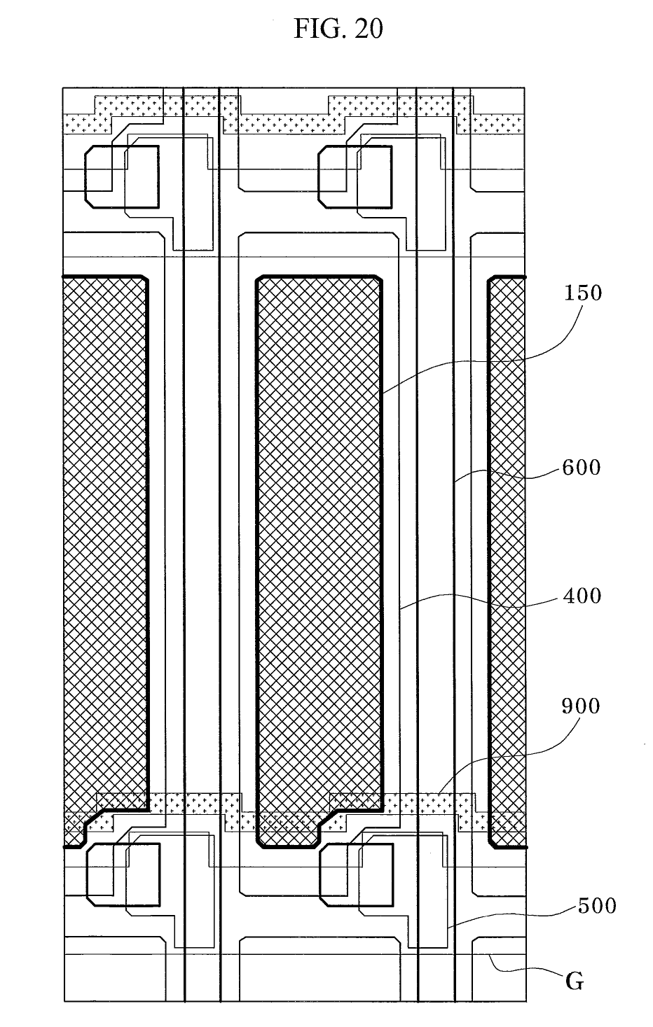

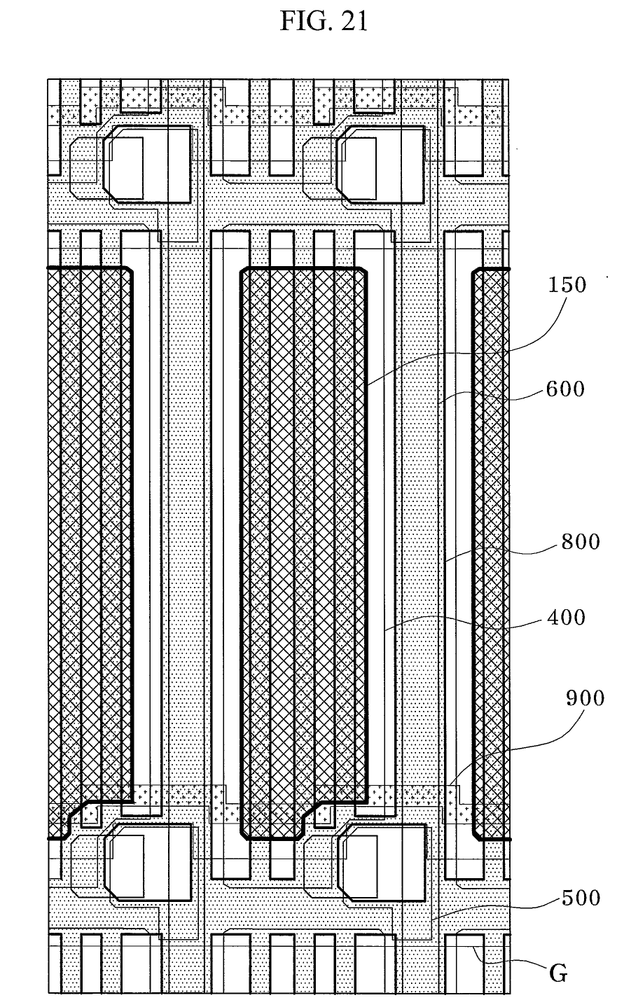

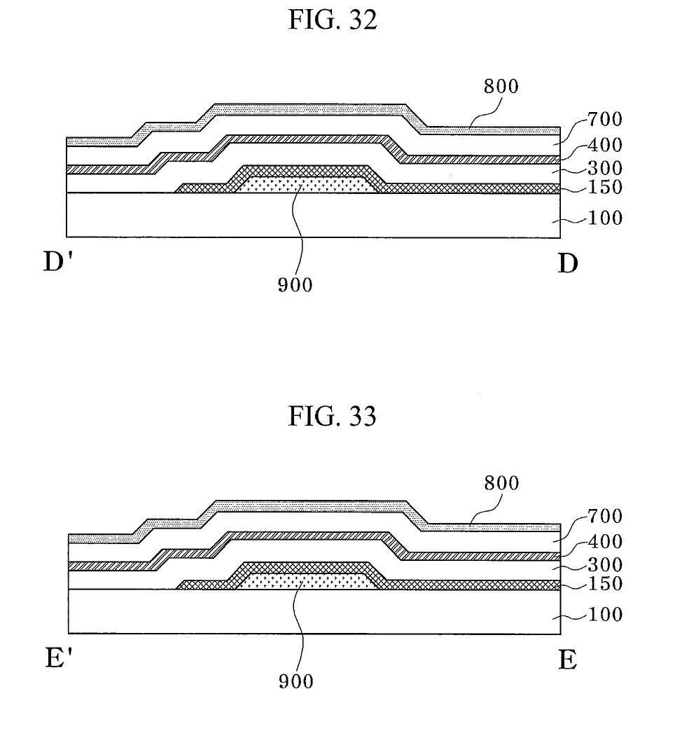

FIG. 15 is a plan view showing a portion of a pixel region of a lower substrate of an FFS mode LCD in accordance with a second exemplary embodiment of the present invention, FIG. 16 to FIG. 21 are plan views sequentially showing steps of forming respective layers and overlapping the layers and FIG. 32 is a cross-sectional view taken along line D-D′ of FIG. 15.

The structure of the lower substrate applied to the second exemplary embodiment of the present invention is similar to that applied to the first exemplary embodiment as described above, and for the convenient of explanation, numeral references and names as the first exemplary embodiment will be used for the same elements as the first exemplary embodiment.

Furthermore, mainly explaining the difference in the lower substrate of the FFS mode LCD in accordance with the first exemplary embodiment of the present invention as shown in FIG. 4, it is a core difference that in order to effectively reduce the resistance of a common portion (i.e. the transparent auxiliary capacitive electrode) of the lower side, a common line for reducing resistance 900 is formed on the same layer as the gate line G using the same material (i.e. Mo) as the gate line G at the time of forming the gate line G, and that the transparent auxiliary capacitive electrode 150 is formed covering a portion of the common line for reducing resistance 900 so as to be electrically connected to the common line for reducing resistance 900.

That is, referring to FIG. 15 to FIG. 21 and FIG. 32, the common line for reducing resistance 900 parallel to the gate line G is disposed in the edge part (i.e. a place adjacent to the gate line G) of the pixel spaced apart from the gate line G The common line for reducing resistance 900 is formed on the same layer as the gate line G and is electrically connected to the transparent common electrode 800, thereby continuously applying common signals to the transparent common electrode 800.

That is, as shown in FIG. 11 and FIG. 12, like the connection structure of the transparent auxiliary capacitive electrodes 150 applied to the first exemplary embodiment, the common line for reducing resistance 900 is electrically connected to the conventional common bus line CB formed at a non-display region of an outer periphery of the lower substrate through the contact hole CH1. The common bus line CB is formed at the non-display region of the outer periphery of the lower substrate along a circumference of the pixel region and applies a common voltage signal Vcom to the transparent auxiliary capacitive electrodes 150 through the common line for reducing resistance 900 to form an additional auxiliary capacitance Cst′.

Furthermore, transparent common electrode 800 is electrically connected to the common bus line CB through the contact hole CH2, and the common voltage signal Vcom is applied to the transparent common electrode 800 and cooperates with a pixel voltage of the transparent pixel electrode 400 formed on the substrate 100 to form a fringe field, thereby driving liquid crystal molecules.

Particularly, in the second exemplary embodiment of the present invention, a transparent auxiliary capacitive electrode 150 disposed on the same layer as the gate line G formed on the lower substrate 100 before forming the gate insulating layer 300 is provided.

The transparent auxiliary capacitive electrode 150 may be formed covering a portion of the common line for reducing resistance 900 to be electrically connected directly to the common line for reducing resistance 900 without a separate contact hole, thereby improving the total load. Also, this effectively improves the greenish phenomenon occurring at a specific pattern by making the return of a common voltage rapidly at the time of voltage holding.

The transparent auxiliary capacitive electrode 150 is funned to overlap a part of the transparent pixel electrode 400, and preferably, has an area included in the transparent pixel electrode 400 in a plan view.

Hereinafter, a method of fabricating an FFS mode LCD in accordance with the second exemplary embodiment of the present invention will be described in detail with reference to FIGS. 15 to 21 and FIG. 32.

Referring to FIGS. 15 to 21 and FIG. 32, in a lower substrate applied to the second exemplary embodiment of the present invention, a gate line G having a gate electrode 200 is formed on a substrate 100, and a predetermined common line for reducing resistance 900 spaced apart from each gate line G and on the same layer as the gate line G using the same material (e.g., Mo) as the gate line G is formed.

And then, the transparent auxiliary capacitive electrode 150 is formed on the substrate 100 of the same layer as the gate line G. That is, the transparent auxiliary capacitive electrode 150 is formed so as to cover a portion of the common line for reducing resistance 900 and overlap a portion of a transparent pixel electrode 400 in each unit pixel region by the deposition of a transparent metal layer and patterning thereof.

After this, a gate insulating layer 300 is deposited on the entire upper part of the substrate 100 so as to cover the gate line G including the gate electrode 200 and the transparent auxiliary capacitive electrode 150, and then an a-Si layer and an n+ a-Si layer are sequentially deposited on the resultant substrate and then patterned to form an active pattern 500 on a portion of the gate insulating layer 300 of the upper part of the gate electrode 200.

Next, the transparent pixel electrode 400 in a plate shape is formed to be disposed on the gate insulating layer 300 in the unit pixel region by depositing and patterning a transparent conductive layer. After this, a metal layer for source and drain electrodes is deposited and then patterned to form a data line 600 including source and drain electrodes 600a and 600b, thereby constituting a TFT T. Here, the drain electrode 600b is configured to be electrically connected to the transparent pixel electrode 400.

Next, an insulating layer 700 formed of, for example, a SiNx material is applied on the resultant structure, in which the TFT T is formed, and then, a transparent common electrode 800 having a slit shape is formed to overlap at least a portion of the transparent pixel electrode 400. Next, while not shown, an alignment layer is applied on the uppermost part of the resultant substrate, on which the transparent common electrode 800 is formed, thereby completing the manufacture of an array substrate.

Moreover, a color filter is selectively formed on the upper substrate, and an alignment layer is formed on the upper part thereof. The upper and lower substrates are bonded to each other with a liquid crystal layer interposed therebetween to complete the FFS mode LCD in accordance with the second exemplary embodiment of the present invention. Of course, preferably, after bonding the substrates, polarizers may be attached to outer surfaces of the substrates.

### Third Exemplary Embodiment

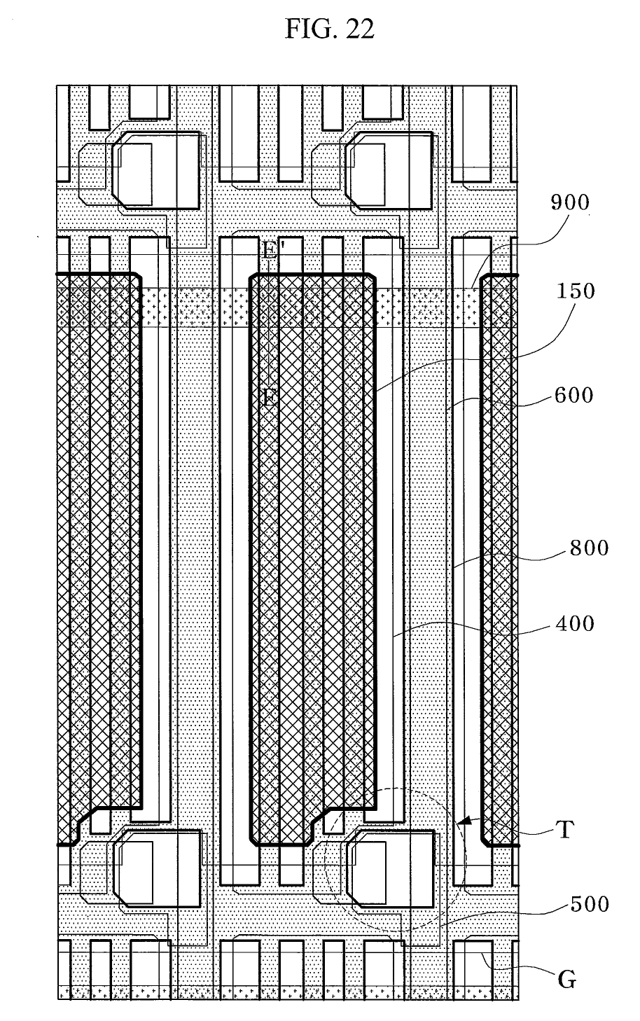

FIG. 22 is a plan view showing a portion of a pixel region of a lower substrate of an FFS mode LCD according to the manufacturing processes in accordance with a third exemplary embodiment of the present invention and FIG. 33 is a cross-sectional view taken along line E-E′ of FIG. 22.

Referring to FIG. 22 and FIG. 33, comparing the lower substrate of the FFS mode LCD device in accordance with the third exemplary embodiment of the present invention with that in accordance with the second exemplary embodiment of the present invention as described above, there is only a difference in the position where the common line for reducing resistance 900 is disposed, and the lower substrate of the FFS mode LCD device in accordance with the third exemplary embodiment of the present invention is identical with that in accordance with the second exemplary embodiment of the present invention with respect to the structure and the manufacture method thereof. Therefore, the detailed explanation therefor is referred to the second exemplary embodiment.

The common line for reducing resistance 900 applied to the second exemplary embodiment is disposed parallel to the gate line G and in the edge part of the pixel spaced apart from the gate line G (a lower side portion of the gate line when the substrate is seen from above). Like the second exemplary embodiment as described above, the common line for reducing resistance 900 is formed on the same layer as the gate line G and is electrically connected to the transparent common electrode 800, thereby continuously applying common signals to the transparent common electrode 800.

### Fourth Exemplary Embodiment

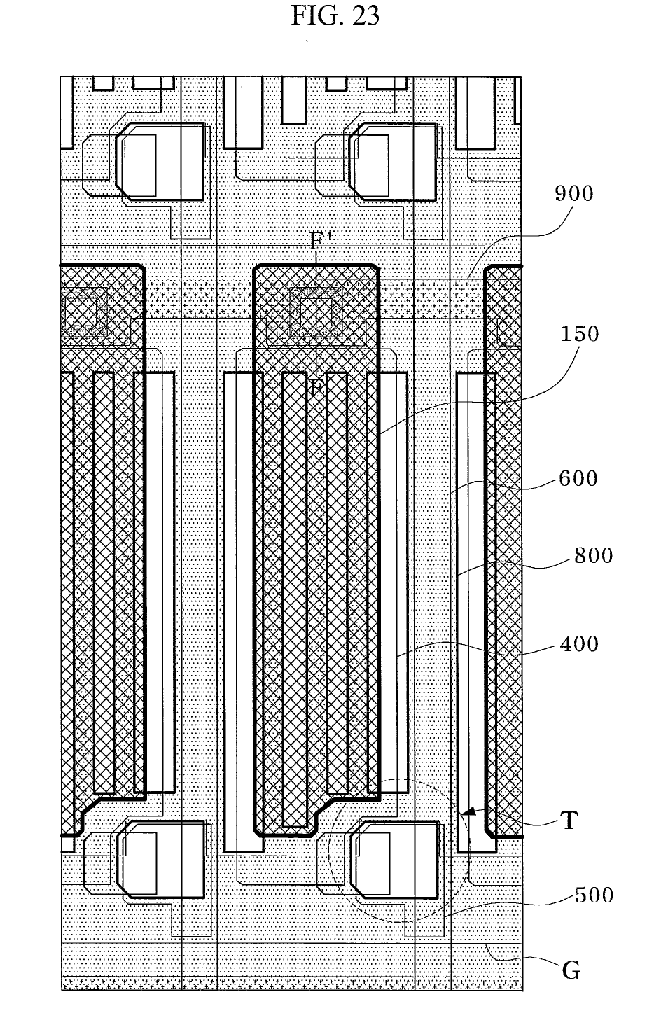

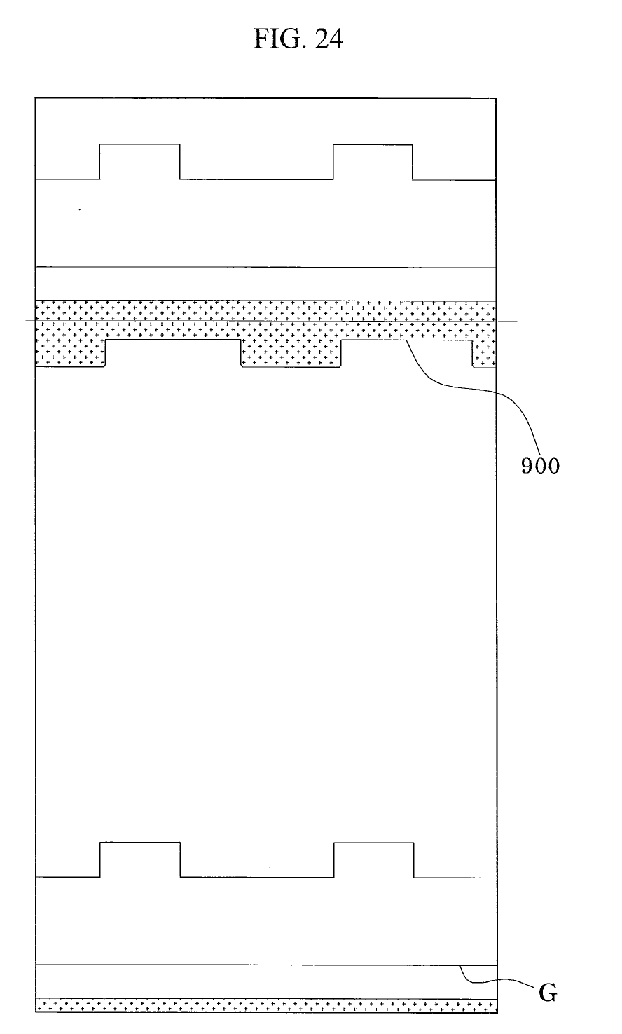

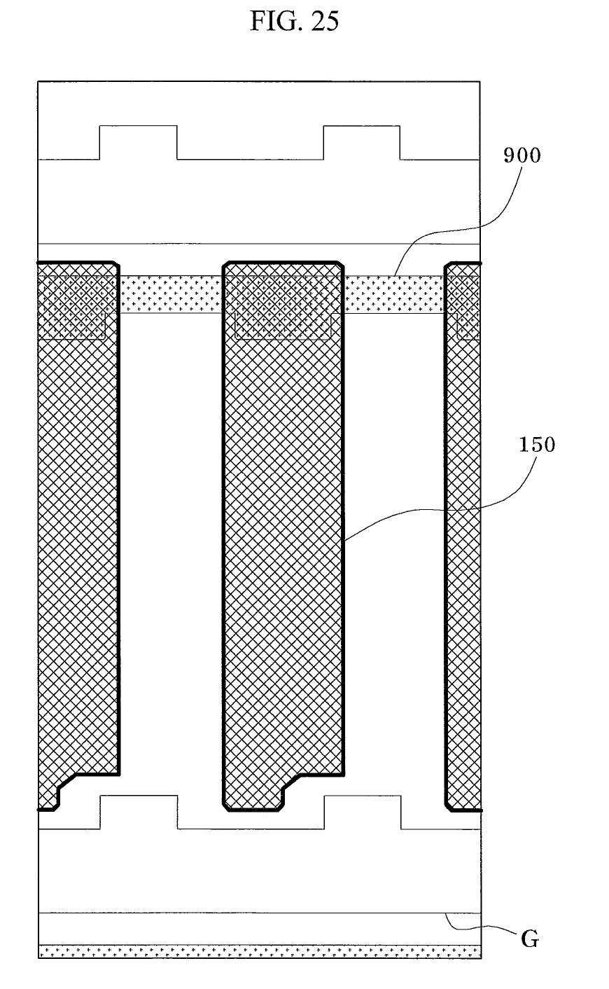

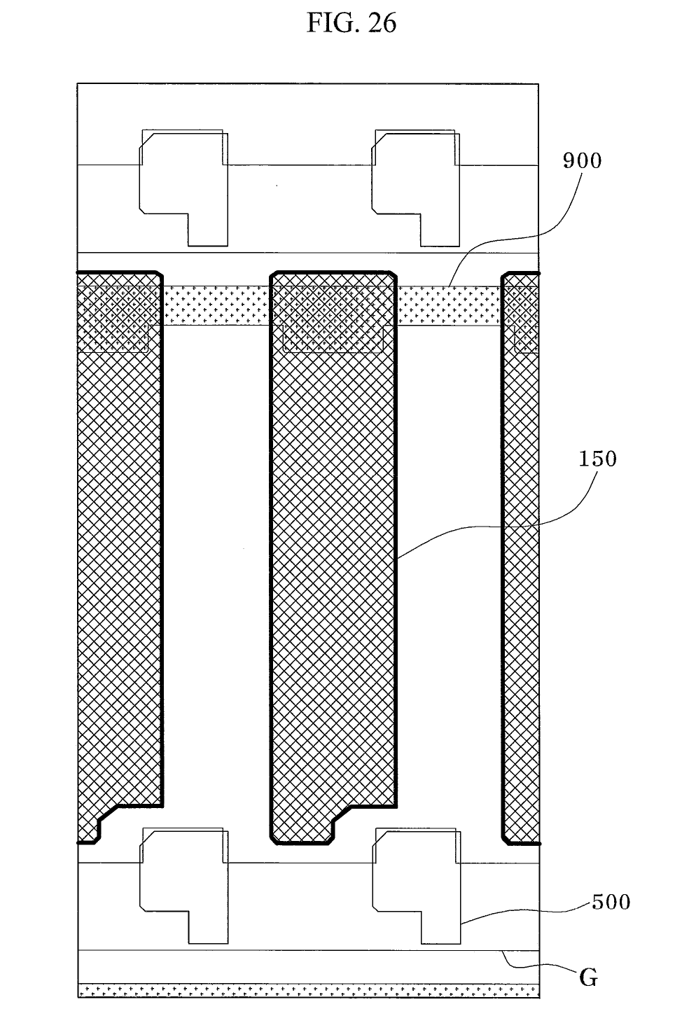

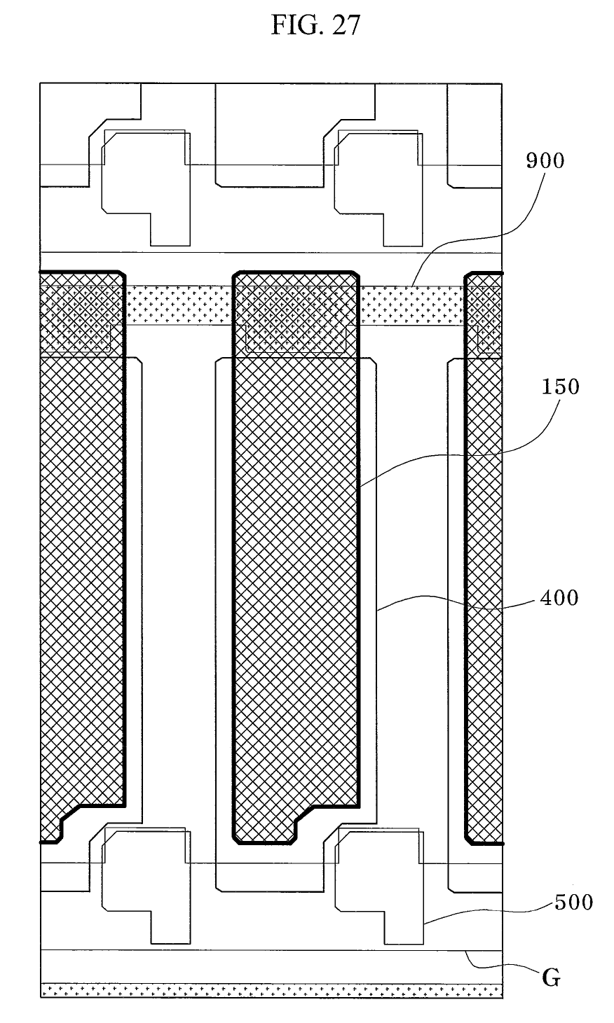

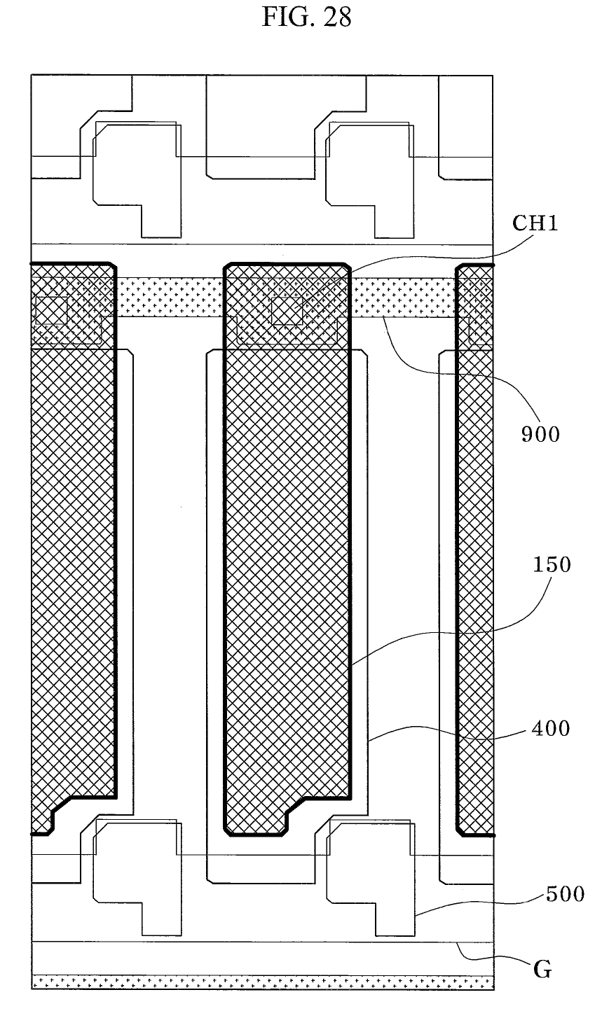

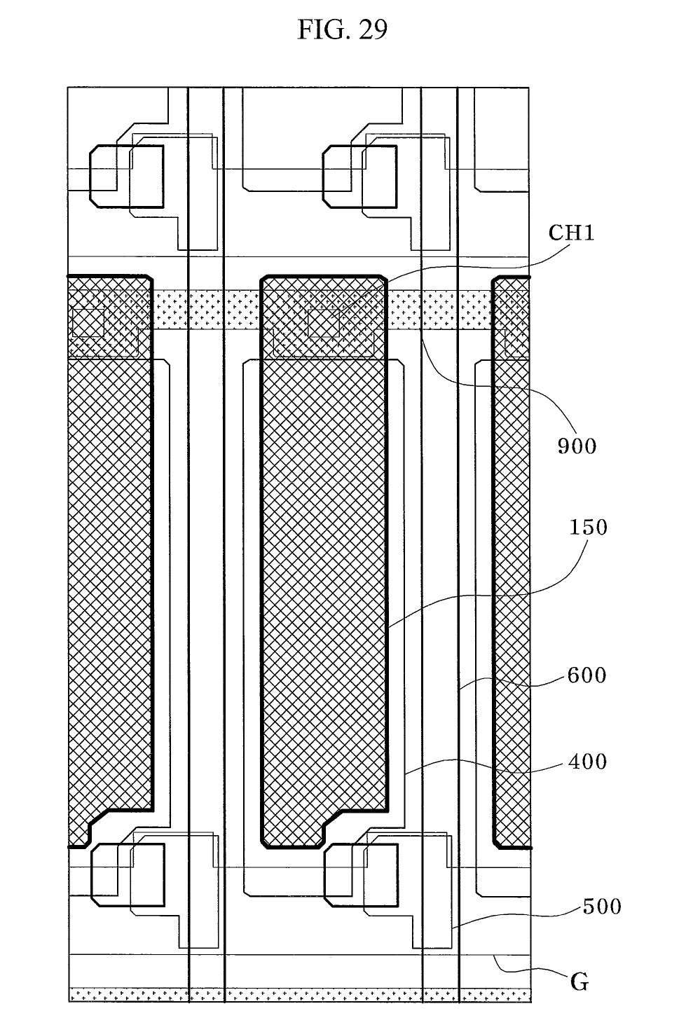

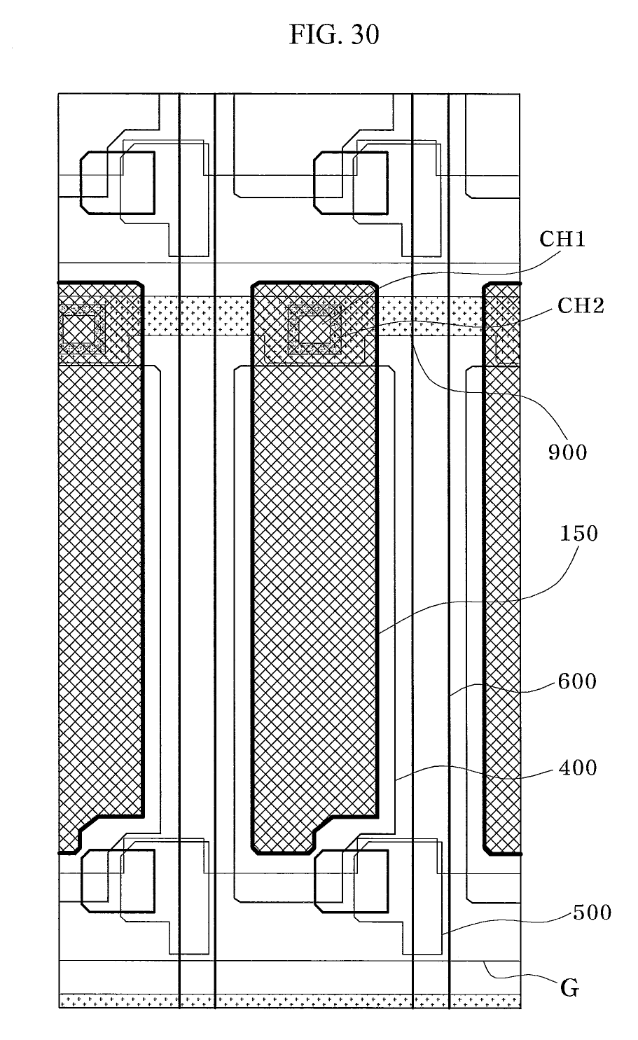

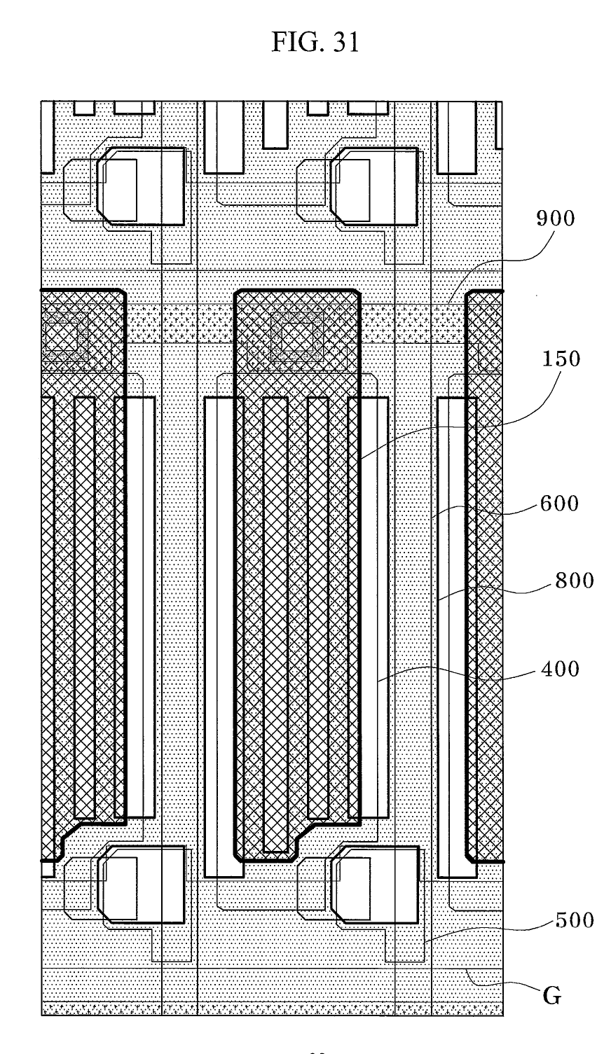

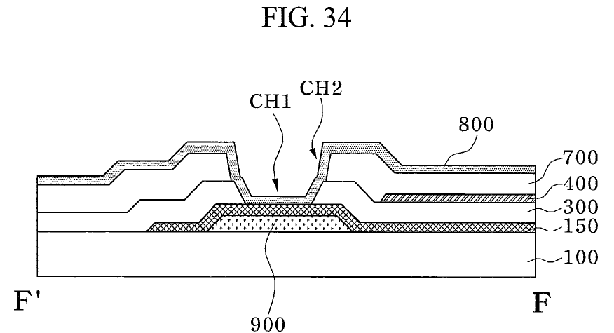

FIG. 23 is a plan view showing a portion of a pixel region of a lower substrate of an FFS mode LCD in accordance with a fourth exemplary embodiment of the present invention, FIG. 24 to FIG. 31 are plan views sequentially showing steps of forming respective layers and overlapping the layers, and FIG. 34 is a cross-sectional view taken along line F-F′ of FIG. 23.

The structure of the lower substrate applied to the fourth exemplary embodiment of the present invention is similar to that applied to the third exemplary embodiment as described above, and for conveniently explaining, numeral references and names as the third exemplary embodiment will be used for the same elements as the third exemplary embodiment.

Furthermore, mainly explaining the difference in the lower substrate of the FFS mode LCD in accordance with the fourth exemplary embodiment of the present invention as shown in FIG. 23, it is a core difference that in order to effectively reduce the resistance of a common portion (i.e. the transparent common electrode and the transparent auxiliary capacitive electrode) of the upper and lower sides, first and second contact holes (CH1 and CH2) are formed on the gate insulating layer 300 and insulating layer 700 so that a portion of the transparent auxiliary capacitive electrode 150 which is directly connected to the common line 900 for reducing resistance is exposed, and that the transparent auxiliary capacitive electrode 150 which is exposed through the first and second contact holes CH1 and CH2, and the transparent common electrode 800 are electrically connected to each other.

In an FFS mode LCD having a big size, the resistance of the transparent common electrode 800 increases according to the size thereof, thereby occurring a problem such as the delay of common signals. If the fourth exemplary embodiment of the present invention is applied thereto, when forming the transparent common electrode 800, the transparent auxiliary capacitive electrode 150 which is exposed through the first and second contact holes CH1 and CH2, the transparent common electrode 800, and the common line for reducing resistance 900 are formed to be electrically connected to each other in the unit pixel region, thereby improving all resistance of the common portions of the upper and lower sides (i.e. the transparent common electrode and transparent auxiliary capacitive electrode) by using one common line for reducing resistance 900.

Moreover, a connection relationship between the common line for reducing resistance 900 and the common bus line CB (see FIG. 11 and FIG. 12) formed at the non-display region of the outer periphery of the lower substrate is identical with the second and third exemplary embodiments, so the detailed description thereof will be omitted.

Hereinafter, a method of fabricating an FFS mode LCD in accordance with the fourth exemplary embodiment of the present invention will be described in detail with reference to FIGS. 23 to 31 and FIG. 34.

Referring to FIGS. 23 to 31 and FIG. 34, in a lower substrate applied to the fourth exemplary embodiment of the present invention, a gate line G having a gate electrode 200 is first formed on a substrate 100, and a predetermined common line for reducing resistance 900 spaced apart from each gate line G is formed on the same layer as the gate line G using the same material as the gate line G (e.g., Mo).

And then, the transparent auxiliary capacitive electrode 150 is formed on the substrate 100 of the same layer as the gate line G. That is, the transparent auxiliary capacitive electrode 150 is formed so as to cover a portion of the common line for reducing resistance 900 and overlap a portion of the transparent pixel electrode 400 in each unit pixel region by the deposition of a transparent metal layer and patterning thereof.

After this, the gate insulating layer 300 is deposited on the entire upper part of the substrate 100 so as to cover the gate line G including the gate electrode 200 and the transparent auxiliary capacitive electrode 150, and then an a-Si layer and an n+ a-Si layer are sequentially deposited on the resultant substrate and then patterned to form an active pattern 500 on a portion of the gate insulating layer 300 of the upper part of the gate electrode 200.

The transparent pixel electrode 400 in a plate shape is formed to be disposed on the gate insulating layer 300 in the unit pixel region by depositing and patterning the transparent conductive layer, and thereafter, the first contact hole CH1 is formed so that a predetermined region of the transparent auxiliary electrode 150 is exposed.

That is, the first contact hole CH1 is formed by etching the gate insulating layer 300 so that the predetermined region of the transparent auxiliary electrode 150 which comes into contact with the common line for reducing resistance 900 is exposed.

After this, a metal layer for source and drain electrodes is deposited and then patterned to form a data line 600 including source and drain electrodes 600a and 600b (see FIG. 9), thereby constituting a TFT T. Here, the drain electrode 600b is configured to be electrically connected to the transparent pixel electrode 400.

Next, an insulating layer 700 formed of, for example, a SiNx material is applied on the resultant structure, in which the TFT T is formed, and then, the second contact hole CH2 is formed at the same position as the first contact hole CH1 by etching the insulating layer 700 so that the predetermined region of the transparent auxiliary capacitive electrode 150 is exposed.

And then, a transparent common electrode 800 having a slit shape is formed to overlap at least a portion of the transparent pixel electrode 400. At this time, the transparent common electrode 800 is electrically connected to the transparent auxiliary capacitive electrode 150 exposed through the first and second contact holes CH1, CH2.

Next, while not shown, an alignment layer is applied on the uppermost part of the resultant substrate, on which the transparent common electrode 800 is formed, thereby completing the manufacture of an array substrate.

Moreover, a color filter is selectively formed on the upper substrate, and the alignment layer is formed on the upper part thereof. The upper and lower substrates are bonded to each other with a liquid crystal layer interposed therebetween to complete the FFS mode LCD in accordance with the fourth exemplary embodiment of the present invention. Of course, preferably, after bonding the substrates, polarizers may be attached to outer surfaces of the substrates.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines, the LCD comprising:
a transparent pixel electrode disposed in the pixel region to adjust optical transmittance by applying an electric field to the liquid crystal layer, and a transparent common electrode spaced apart from and overlapping the transparent pixel electrode in a predetermined region with an insulating layer interposed therebetween, and
a transparent auxiliary capacitive electrode spaced apart from and overlapping the transparent pixel electrode in a predetermined region with the gate insulating layer interposed therebetween,
wherein the transparent auxiliary capacitive electrode is electrically connected to a common bus line formed on a non-display region of an outer periphery of the lower substrate through a contact hole, and the common bus line is connected to the transparent common electrode.

2. The FFS mode LCD according to claim 1, wherein the transparent auxiliary capacitive electrodes disposed in the pixel regions parallel to the gate line are electrically connected to each other.

3. A fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines, the LCD comprising:
a common line for reducing resistances disposed on the same layer as the gate lines and spaced apart from each gate line;
a transparent pixel electrode disposed in the unit pixel region to adjust optical transmittance by applying an electric field to the liquid crystal layer, and a transparent common electrode spaced apart from and overlapping the transparent pixel electrode in a predetermined region with an insulating layer interposed therebetween; and
a transparent auxiliary capacitive electrode spaced apart from and overlapping the transparent pixel electrode in a predetermined region with a gate insulating layer interposed therebetween,
wherein the transparent auxiliary capacitive electrode is formed covering a portion of the common line for reducing resistance so as to be electrically connected to the common lines for reducing resistance.

4. The FFS mode LCD according to claim 3, wherein the transparent common electrode is electrically connected to the transparent auxiliary capacitive electrode through a contact hole formed on the insulating layer and the gate insulating layer.

5. The FFS mode LCD according to claim 1, wherein the transparent common electrode includes a plurality of slits having a predetermined width.

6. The FFS mode LCD according to claim 3, wherein the transparent common electrode includes a plurality of slits having a predetermined width.

7. The FFS mode LCD according to claim 1, wherein the transparent auxiliary capacitive electrode has an area included in the transparent pixel electrode in a plan view.

8. The FFS mode LCD according to claim 3, wherein the transparent auxiliary capacitive electrode has an area included in the transparent pixel electrode in a plan view.

9. The FFS mode LCD according to claim 1, wherein the transparent pixel electrode has a plate shape.

10. The FFS mode LCD according to claim 3, wherein the transparent pixel electrode has a plate shape.

11. The FFS mode LCD according to claim 1, wherein the transparent pixel electrode is formed on the same layer as the data line.

12. The FFS mode LCD according to claim 3, wherein the transparent pixel electrode is formed on the same layer as the data line.

13. A method of fabricating a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines, the method comprising:
forming a gate line having a gate electrode on a substrate, and forming a transparent auxiliary capacitive electrode to overlap a portion of a transparent pixel electrode in each unit pixel region;
forming a gate insulating layer on the entire upper part of the substrate so as to cover the gate line having the gate electrode and the transparent auxiliary capacitive electrode, and forming the transparent pixel electrode in each unit pixel region on the gate insulating layer;
forming an active pattern on a portion of the gate insulating layer on an upper part of the gate electrode, and forming a first contact hole in a non-display region of an outer periphery of the lower substrate so as to expose the transparent auxiliary capacitive electrode using a contact mask;
forming source and drain electrodes and a data line on the portion of the gate insulating layer on the gate electrode to constitute a switching device, and simultaneously, forming a common bus line in the non-display region of the outer periphery of the lower substrate to be electrically connected to the transparent auxiliary capacitive electrode through the first contact hole;
forming an insulating layer on the resultant structure on which the switching device is formed, and forming a second contact hole in the non-display region of the outer periphery of the lower substrate; and
forming a transparent common electrode on the insulating layer to overlap at least a portion of the transparent pixel electrode and to be electrically connected to the common bus line through the second contact hole.

14. The method according to claim 13, wherein the transparent auxiliary capacitive electrodes disposed in the pixel regions parallel to the gate line are electrically connected to each other.

15. A method of fabricating a fringe field switching mode (FFS mode) liquid crystal display device (LCD) including a lower substrate, an upper substrate, and a liquid crystal layer disposed between the substrates, the lower substrate including unit pixel regions defined by gate lines and data lines formed to intersect each other and switching devices disposed on intersections of the gate and data lines, the method comprising:
forming a gate line having a gate electrode on a substrate, and simultaneously, forming a common line for reducing resistance on the same layer as the gate lines using the same material as the gate lines so to be spaced apart from each gate lines;
forming a transparent auxiliary capacitive electrode covering a portion of the common lines for reducing resistance and overlapping a portion of a transparent pixel electrode in each unit pixel region;
forming a gate insulating layer on the entire upper part of the substrate to cover the gate line having the gate electrode and the transparent auxiliary capacitive electrode;
forming an active pattern on a portion of the gate insulating layer on an upper part of the gate electrode, and forming the transparent pixel electrode to be disposed in each unit pixel region on the gate insulating layer;
forming source and drain electrodes and a data line on the portion of the gate insulating layer on the upper part of the gate electrode to constitute a switching device, and forming an insulating layer on the resultant structure on which the switching device is formed; and
forming a transparent common electrode on the insulating layer.

16. The method according to claim 15, wherein after the transparent pixel electrode is formed, the first contact hole is formed so that a predetermined region of the transparent auxiliary capacitive electrode is exposed, and after the insulating layer is formed, the second contact hole is formed at the same position as the first contact hole so that a predetermined region of the transparent auxiliary capacitive electrode is exposed, and the transparent common electrode is formed to be electrically connected to the transparent auxiliary capacitive electrode through the first and second contact holes.

17. The method according to claim 13, wherein the transparent auxiliary capacitive electrode has an area included in the transparent pixel electrode in a plan view.

18. The method according to claim 15, wherein the transparent auxiliary capacitive electrode has an area included in the transparent pixel electrode in a plan view.

19. The method according to claim 13, wherein the transparent pixel electrode has a plate shape.

20. The method according to claim 15, wherein the transparent pixel electrode has a plate shape.

21. The method according to claim 13, wherein the transparent pixel electrode is formed on the same layer as that of the data line.

22. The method according to claim 15, wherein the transparent pixel electrode is formed on the same layer as that of the data line.
